(19) United States
(12) Patent Application Publication
(10) Pub. No.: US 2010/0050224 A1
(43) Pub. Date: Feb. 25, 2010

(54) DISPLAY APPARATUS AND CONTROL METHOD THEREOF

(75) Inventor: Chul-ju KIM, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/406,698

(22) Filed: Mar. 18, 2009

(30) Foreign Application Priority Data
Aug. 25, 2008 (KR) 10-2008-0083011

(51) Int. Cl. H04N 7/16; H04N 5/66

(52) U.S. Cl. 725/135; 348/739; 348/E05.133

(57) ABSTRACT

A display apparatus and a control method thereof are provided. The display apparatus includes: a video processing unit which processes a first video; a display unit which displays the first video; a connecting unit which receives a second video of an image communication from a mobile communication terminal which enables the image communication; and a control unit which controls the video processing unit to process the second video of the image communication to display the second video in the display unit, and controls the mobile communication terminal based on a control command of a user.

### CROSS-REFERENCE TO RELATED APPLICATION

This application claims priority from Korean Patent Application No. 10-2008-0083011, filed on Aug. 25, 2008 in the Korean Intellectual Property Office, the disclosure of which is incorporated herein by reference.

### BACKGROUND OF INVENTION

1. Field of Invention

The present invention relates to a display apparatus and a control method thereof, and more particularly, to a display apparatus using a mobile communication terminal which enables an image communication and a control method thereof.

2. Description of Related Art

A third generation (3G) phone, a third generation mobile communication terminal, has experienced a rapidly increasing supply and demand and enables an image communication providing a differentiated communication service in comparison with an existing mobile communication terminal.

A display apparatus receives a video signal through an external device such as a computer, a digital versatile disk (DVD) player, and a video player, or through various media sources such as a satellite, and a cable, and processes and displays the video signal. Also, the display apparatus may process an audio signal received together with the video signal to be output through a speaker.

However, since the mobile communication terminal such as the 3G phone has a small screen for displaying an image, it is inconvenient for a plurality of users to use one mobile communication terminal together, and there is a limit to information transmission. To facilitate the image communication in a home or an office environment, separate equipment such as a camera, a communication system, a microphone, and a display device may be required and thus additional cost may incur.

The image communication by using the mobile communication terminal such as the 3G phone has well-established infrastructure, and the display apparatus has been widely used. Accordingly, if image communication information sent and received by using the mobile communication terminal like the 3G phone can be output to the display apparatus, an image communication service will be possible without purchasing or connecting such separate equipment.

### SUMMARY OF THE INVENTION

An aspect of the present invention provides a display apparatus, including: a video processing unit which processes a first video; a display unit which displays the first video; a connecting unit which receives a second video of an image communication from a mobile communication terminal which enables the image communication; and a control unit which controls the video processing unit to process the second video of the image communication to display the second video in the display unit, and controls the mobile communication terminal based on a control command of a user.

The control unit may control the video processing unit to concurrently display the first video and the second video of the image communication.

The control command of the user may include a control command about an operation of the mobile communication terminal, and the operation includes executing of the image communication, ending of the image communication and adjusting the volume of an audio of the image communication.

The control unit may control the video processing unit to display a message about an operation of the mobile communication terminal, and the operation includes executing of the image communication, ending of the image communication and adjusting the volume of an audio of the image communication in the display unit.

The display apparatus may further include an audio input unit which receives an audio of a user, wherein the control unit may control the mobile communication terminal to transmit the received audio.

The display apparatus may further include an audio processing unit which processes a first audio, and an audio output unit which outputs the first audio, wherein the connecting unit receives a second audio of the image communication from the image communication terminal and the control unit may control the audio processing unit to process the second audio of the image communication to be output through the audio output unit.

The control unit may control the audio processing unit to concurrently output the first audio and the second audio of the image communication.

The control unit may control the audio processing unit to adjust at least one volume of the first audio and the second audio of the image communication.

Another aspect of the present invention provides a control method of a display apparatus, including: displaying a first video; receiving a second video of an image communication from a mobile communication terminal which enables the image communication; and controlling displaying of the second video and the mobile communication terminal based on a control command of a user.

The first video and the second video of the image communication may be concurrently displayed.

The control command of the user may include a control command about an operation of the mobile communication terminal, and the operation includes executing of the image communication, ending of the image communication and adjusting the volume of an audio of the image communication.

The control method of the display apparatus may further include displaying a message about an operation of the mobile communication terminal, and the operation includes executing of the image communication, ending of the image communication and adjusting the volume of an audio of the image communication.

The control method of the display apparatus may further include receiving an audio of a user, and transmitting the received audio of the user through the mobile communication terminal.

The control method of the display apparatus may further include outputting a first audio, and receiving a second audio of the image communication from the mobile communication terminal and outputting the second audio through an audio output unit.

The first audio and the second audio of the image communication may be concurrently output.

The control method of the display apparatus may further include adjusting at least one volume of the first audio and the second audio of the image communication.

### BRIEF DESCRIPTION OF DRAWINGS

Aspects of the present invention will become apparent and more readily appreciated from the following description of the exemplary embodiments, taken in conjunction with the accompanying drawings, in which:

FIG. 1 is a diagram schematically illustrating an overall configuration of a display apparatus using a mobile communication terminal according to an exemplary embodiment of the present invention;

FIG. 2 is a control block diagram illustrating the display apparatus using the mobile communication terminal according to the exemplary embodiment of the present invention; and

FIG. 3 is a flowchart illustrating a process in which a first video and a first audio of a broadcasting and a second video and a second audio of an image communication are processed in the display apparatus according to the exemplary embodiment of the present invention.

### DETAILED DESCRIPTION OF EXEMPLARY EMBODIMENTS

Reference will now be made in detail to embodiments of the present invention, examples of which are illustrated in the accompanying drawings, wherein like reference numerals refer to like elements. The exemplary embodiments are described below so as to explain the present invention by referring to the figures. Repetitive description with respect to like elements of different embodiments may be omitted for the sake of clarity.

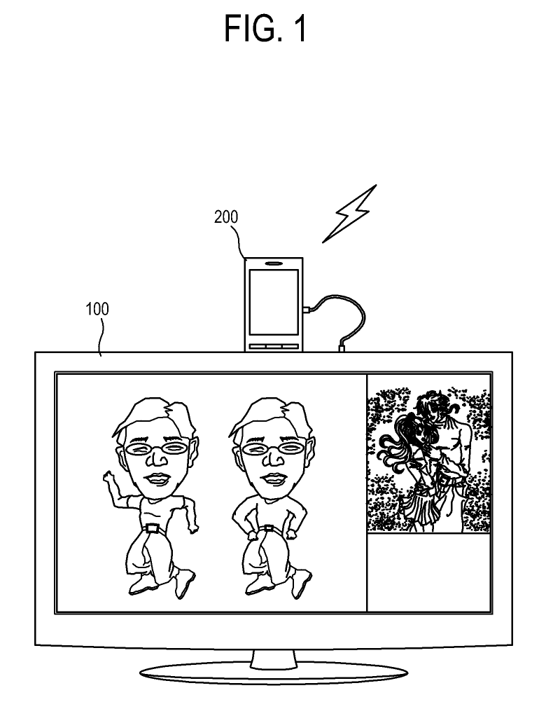

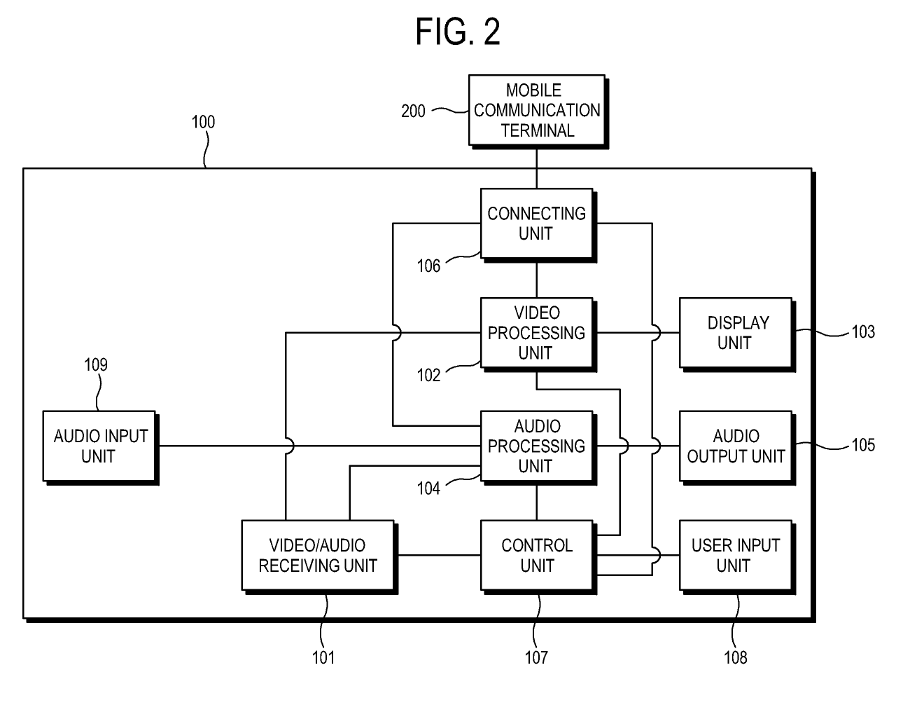

FIG. 1 is a diagram schematically illustrating an overall configuration of a display apparatus using a mobile communication terminal according to an exemplary embodiment of the present invention, and FIG. 2 is a control block diagram illustrating the display apparatus using the mobile communication terminal according to the exemplary embodiment of the present invention.

Referring to FIG. 1, a display apparatus 100 according to the exemplary embodiment of the present invention processes and displays a video received through an external device, a satellite, a cable, etc. (hereinafter, will be referred to as “a first video of a broadcasting”), and a video of an image communication received through a mobile communication terminal 200 such as a 3G phone (hereinafter, will be referred to as “a second video of an image communication”). Also, the display apparatus 100 according to the exemplary embodiment of the present invention processes and outputs an audio received through an external device, a satellite, a cable, etc. (hereinafter, will be referred to as “a first audio of a broadcasting”), and an audio of an image communication received through the mobile communication terminal 200 such as a 3G phone (hereinafter, will be referred to as “a second audio of an image communication”).

Referring to FIG. 2, the display apparatus 100 according to the exemplary embodiment of the present invention includes a video/audio receiving unit 101 receiving the first video of the broadcasting, a video processing unit 102 processing the first video of the broadcasting, a display unit 103 displaying the first video of the broadcasting, a connecting unit 106 receiving the second video of the image communication from the mobile communication terminal 200, and a control unit 107 controlling the video processing unit 102 to process and display the received second video of the image communication.

The display apparatus 100 further includes an audio processing unit 104 processing the first audio of the broadcasting, an audio output unit 105 outputting the processed first audio of the broadcasting, a user input unit 108 receiving a control command of a user for operating the display apparatus 100 and the mobile communication terminal 200, and an audio input unit 109 receiving an audio of a user.

The video/audio receiving unit 101 receives the first video and the first audio of the broadcasting, and transmits the first video and the first audio to the video processing unit 102 and the audio processing unit 104, respectively. For example, the first video and the first audio of the broadcasting may be a broadcasting signal including a video and an audio corresponding to each channel according to a frequency band, and also may be video and audio signals received from an external device such as a computer (not shown). The video/audio receiving unit 101 may be implemented as having various configurations to receive the first video and the first audio of the broadcasting. For example, the video/audio receiving unit 101 may include an antenna (not shown) receiving a broadcasting signal broadcasted wirelessly, or may receive a broadcasting signal by wire through a cable connected to a broadcasting station. Also, the video/audio receiving unit 101 may include various connectors capable of receiving video and audio signals from an external device such as a computer, a digital versatile disk (DVD) player, and an electronic game device.

The video processing unit 102 processes the first video of the broadcasting received from the video/audio receiving unit 101, and displays the first video in the display unit 103. Also, if the video processing unit 102 receives the second video of the image communication from the connecting unit 106, the video processing unit 102 processes the second video, and displays the second video in the display unit 103. In this instance, the video processing unit 102 may concurrently display the second video of the image communication and the first video of the broadcasting, or may individually display the first video and the second video in respective screens. If the received second video of the image communication includes a character information, the video processing unit 102 may process the information as described above, and may concurrently display the second video together with the first video of the broadcasting. Accordingly, the video processing unit 102 may employ various technologies such as decoders decoding a received video, a picture in picture (PIP) function, a scaler, and an image correction.

The audio processing unit 104 respectively processes the first audio of the broadcasting received from the video/audio receiving unit 101, and the second audio of the image communication received from the connecting unit 106 and outputs the processed audios through the audio output unit 105 according to a control of the control unit 107. If the second audio of the image communication is to be output while the first audio of the broadcasting is output through the audio output unit 105, the audio processing unit 104 concurrently outputs the first audio of the broadcasting and the second audio of the image communication to the audio output unit 105. In this case, the audio processing unit 104 may respectively adjust the volumes of the first audio of the broadcasting and the second audio of the image communication so that a volume-adjusted audio which a user wants can be output.

The display unit 103 may be implemented as a display device including, but not to limited to, a liquid crystal display (LCD), a plasma display panel (PDP), and a cathode ray tube (CRT), and displays a video processed in the video processing unit 104. The display unit 103 may utilize picture in picture (PIP) or picture by picture (PBP) function to divide a single screen into a plurality of sections, and may dividedly display the first video of the broadcasting and the second video of the image communication in each divided screen. Various known configurations may be applied to the PIP or PBP function.

The audio output unit 105 outputs an audio processed in the audio processing unit 104. The audio output unit 105 may include a plurality of speakers (not shown) provided for a plurality of channels, and may concurrently output the first audio of the broadcasting and the second audio of the image communication through a part of the speakers if the first audio of the broadcasting and the second audio of the image communication are concurrently output. That is, the first audio of the broadcasting and the second audio of the image communication may be concurrently output through a single speaker. Also, a part of the plurality of speakers may output the first audio of the broadcasting and the remaining speakers may output the second audio of the image communication. Also, various other configurations may be available.

The connecting unit 106 receives the second video and the second audio of the image communication from the mobile communication terminal 200. Also, the connecting unit 106 may receive a character information from the mobile communication terminal 200. The connecting unit 106 processes the second video of the image communication or the character information received from the mobile communication terminal 200 and transmits the second video or character information to the video processing unit 102, and processes the second audio of the image communication received from the mobile communication terminal 200 and transmits the second audio to the audio processing unit 104.

In the mobile communication terminal such as the 3G phone, the video and the audio of the image communication are input through a camera (not shown) and a microphone (not shown) mounted in the mobile communication terminal 200 itself and transmitted through a mobile communication network. If the microphone mounted in the mobile communication terminal 200 is not able to sufficiently receive an audio of a user, the audio input unit 109 may be provided to the display apparatus 100 to receive the audio of the image communication of the user. In this case, the connecting unit 106 transmits the audio of the image communication input through the audio input unit 109 to the mobile communication terminal 200 according to a control of the control unit 107. The audio of the image communication input to the mobile communication terminal 200 through the connecting unit 106 is transmitted to the mobile communication network together with a video of the image communication input through the camera mounted in the mobile communication terminal 200, and accordingly, the image communication of two-way using the mobile communication terminal 200 and the display apparatus 100 is available.

The connecting unit 106 transmits a control command about an operation of the mobile communication terminal 200 input through the user input unit 108 to the mobile communication terminal 200 according to a control of the control unit 107. Herein, the control command of a user may be a total control command about an operation of the mobile communication terminal 200 including executing of the image communication, ending of the image communication and adjusting of the volume of an audio of the image communication. If the control command about the operation of the mobile communication terminal 200 including the executing of the image communication, the ending of the image communication and the adjusting of the volume of an audio of the image communication is input, the control unit 107 controls the video processing unit 102 so that the operation command can be displayed in the display unit 103. Accordingly, a user can confirm what the control command about the operation of the mobile communication terminal 200 input through the user input unit 108 is.

The connecting unit 106 may be configured to include an encoder and a decoder for processing the second video and the second audio of the image communication received from the mobile communication terminal 200 and for processing an audio of the image communication input through the audio input unit 109, and a local port (not shown) for transmitting the control command about the operation of the mobile communication terminal 200 input through the user input unit 108 according to a control of the control unit 107.

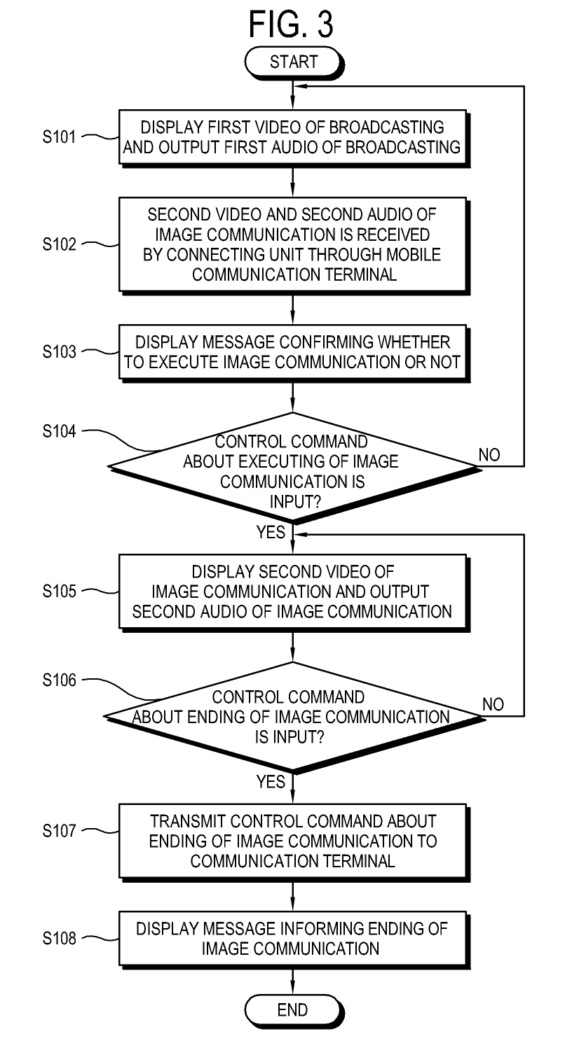

A process in which the control unit 107 of the display apparatus according to the exemplary embodiment of the present invention processes the first video and the first audio of the broadcasting and the second video and the second audio of the image communication will be described by referring to FIG. 3.

As shown in FIG. 3, if the first video and the first audio of the broadcasting are received through the video/audio receiving unit 101, the control unit 107 controls the video processing unit 102 to display the first video of the broadcasting in the display unit 103, and controls the audio processing unit 104 to output the first audio of the broadcasting to the audio output unit 105 (S101).

If the second video and the second audio of the image communication are received by the connecting unit 106 through the mobile communication terminal 200 during displaying of the first video and the outputting of the first audio of the broadcasting (S102), the control unit 107 controls the video processing unit 102 to display a message for confirming whether to execute the image communication or not in the display unit 103 (S103). The control unit 107 determines whether a control command about executing of the image communication is input through the user input unit 108 or not (S104). If the control command about the executing of the image communication is input through the user input unit 108, the control unit 107 controls the video processing unit 102 to display the second video of the image communication in the display unit 103, and controls the audio processing unit 104 to output the second audio of the image communication to the audio output unit 105 (S105). In this instance, the control unit 107 may control the video processing unit 102 to concurrently display the second video of the image communication with the first video of the broadcasting, or to individually display the first video and the second video in respective screen. If the control command about the executing of the image communication is not input through the user input unit 108, the control unit 107 controls the video processing unit 102 and the audio processing unit 104 to keep displaying the first video of the broadcasting and outputting the first audio of the broadcasting.

The control unit 107 determines whether a control command about ending of the image communication is input through the user input unit 108 or not during displaying of the second video of the image communication and outputting of the second audio of the image communication (S106). If the control command about the ending of the image communication is input through the user input unit 108, the control unit 107 controls the connecting unit 106 to transmit a control command for ending the image communication to the mobile communication terminal 200 (S107), and controls the video processing unit 102 to display a message for informing an end of the image communication in the display unit 103 (S108). If the control command about the ending of the image communication is not input through the user input unit 108, the control unit 107 controls the video processing unit 102 and the audio processing unit 104 to keep displaying the second video of the image communication and outputting the second audio of the image communication.

As described above, the present invention may provide a display apparatus and a control method thereof using a mobile communication terminal like a 3G phone which enables an image communication, thereby providing an image communication service without purchasing or connecting a separate device.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus, comprising:
a video processing unit which processes a first video;
a display unit which displays the first video;
a connecting unit which receives a second video of an image communication from a mobile communication terminal which enables the image communication; and
a control unit which controls the video processing unit to process the second video of the image communication to display the second video in the display unit, and controls the mobile communication terminal based on a control command of a user.

2. The display apparatus according to claim 1, wherein the control unit controls the video processing unit to concurrently display the first video and the second video of the image communication.

3. The display apparatus according to claim 1, wherein the control command of the user comprises a control command about an operation of the mobile communication terminal, and the operation comprises executing of the image communication, ending of the image communication and adjusting the volume of an audio of the image communication.

4. The display apparatus according to claim 1, wherein the control unit controls the video processing unit to display a message about an operation of the mobile communication terminal, and the operation comprises executing of the image communication, ending of the image communication and adjusting the volume of an audio of the image communication in the display unit.

5. The display apparatus according to claim 1, further comprising an audio input unit which receives an audio of a user,
wherein the control unit controls the mobile communication terminal to transmit the received audio.

6. The display apparatus according to claim 1, further comprising an audio processing unit which processes a first audio, and
an audio output unit which outputs the first audio,
wherein the connecting unit receives a second audio of the image communication from the image communication terminal and the control unit controls the audio processing unit to process the second audio of the image communication to output the second audio through the audio output unit.

7. The display apparatus according to claim 6, wherein the control unit controls the audio processing unit to concurrently output the first audio and the second audio of the image communication.

8. The display apparatus according to claim 7, wherein the control unit controls the audio processing unit to adjust at least one volume of the first audio and the second audio of the image communication.

9. A control method of a display apparatus, comprising:
displaying a first video;
receiving a second video of an image communication from a mobile communication terminal which enables the image communication; and
controlling displaying of the second video and the mobile communication terminal based on a control command of a user.

10. The control method of the display apparatus according to claim 9, wherein the first video and the second video of the image communication are concurrently displayed.

11. The control method of the display apparatus according to claim 9, wherein the control command of the user comprises a control command about an operation of the mobile communication terminal and the operation comprises executing of the image communication, ending of the image communication and adjusting the volume of an audio of the image communication.

12. The control method of the display apparatus according to claim 9, further comprising displaying a message about an operation of the mobile communication terminal and the operation comprises executing of the image communication, ending of the image communication and adjusting the volume of an audio of the image communication.

13. The control method of the display apparatus according to claim 9, further comprising receiving an audio of a user, and transmitting the received audio of the user through the mobile communication terminal.

14. The control method of the display apparatus according to claim 9, further comprising outputting a first audio, and
receiving a second audio of the image communication from the mobile communication terminal and outputting the second audio through an audio output unit.

15. The control method of the display apparatus according to claim 14, wherein the first audio and the second audio of the image communication are concurrently output.

16. The control method of the display apparatus according to claim 15, further comprising adjusting at least one volume of the first audio and the second audio of the image communication.
